(19) United States
(12) Patent Application Publication
(10) Pub. No.: US 2008/0263630 A1
(43) Pub. Date: Oct. 23, 2008

(54) Confidential File Protecting Method and Confidential File Protecting Device for Security Measure Application

(76) Inventors: Tateki Harada, Tokyo (JP); Hitoshi Kumagai, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/993,349

(22) PCT Filed: Jun. 29, 2006
(86) PCT No.: PCT/JP2006/312976

§ 371 Date: Dec. 20, 2007

(30) Foreign Application Priority Data
Jun. 29, 2005 (JP) 2005-189676

(51) Int. Cl. G06F 21/24; G06F 21/22; H04L 9/32

(52) U.S. Cl. 726/2

(57) ABSTRACT

A confidential file protecting method for a security measure application is provided that can restrain degradation in the performance of a security measure application, and surely protect a confidential file. The confidential file protecting method for a security measure application according to the present invention is characterized by comprising: a first step of communicating between a authentication module for authenticating an application requesting access to the confidential file and a communication module implemented in the security measure application, and authenticating the application as an application permitted to access the confidential file and recording the application as an authenticated application in a management table if the communication module sends back a valid response code; and a second step by said authentication module, of permitting the request to access to said confidential file to access if the access requesting application is an authenticated application that has been recorded in said management table.

### TECHNICAL FIELD

The present invention relates to a method and a device for protecting a confidential file of a security measure application by controlling access to confidential information of the security measure application for each application.

### BACKGROUND ART

In recent years, many accidents happen as in leakage of important personal information such as the flow of customer information, which makes protection of customer information to be great concern to companies.

In addition, the Private Information Protection Law has been in effect since April 2005 to cover all private businesses, rapidly increasing interest in security measure applications.

For a security measure application, it is important to protect confidential information (operating environment definition information or policy definition information, for example) of the application itself in addition to preventing leakage of personal information. There could be a case in that personal information is abusively brought out by exploiting a security hole in a security measure application and tampering definition information of an operating environment.

A scheme to authenticate an application that can access a confidential file includes a technique disclosed in the patent literature 1 below.

According to the technique, a filter module captures an API (Application Programming Interface) issue event from a business application, and the application is authenticated while a file I/O issue is temporarily suspended. A file I/O from a permitted business application is permitted by an I/O monitoring module, while an invalid file I/O is rejected in the mechanism.

Patent Literature 1: JP Patent Publication (Kokai) 2003-108253 A (2003)

### DISCLOSURE OF THE INVENTION

### Problems to be Solved by the Invention

For a security measure application, the most dangerous attack is analysis and tamper of a confidential file that stores confidential information such as an operating environment or policy definition information of the relevant security measure application.

For example, even from a client who sets a policy to inhibit bringing out of any network or external media, his/her confidential information can be easily brought out if a malicious third party rewrites the policy definition information.

The technique disclosed in the above patent literature 1 is a technique appropriate to an access control mechanism when a business application refers to and updates a business document or a table file.

However, protecting a confidential file of the security measure application itself that is responsible for the access control has problems discussed below.

That is, since the technique is an external authentication method of capturing an API issue event, there happen communication processing between a filter module and an application authentication module, and communication processing between the application authentication module and an I/O monitoring module, hence its performance degrades rather than being implemented in an internal code.

Even if the application authentication is limited to be performed only at the time of capturing a file OPEN API, generally, degradation in the performance of the application cannot be prevented since the file OPEN is issued for a number of times.

An object of the present invention is to provide a method of protecting a confidential file of a security measure application that can dynamically perform application authentication in a security measure application, restrain degradation in the performance of the security measure application, and surely protect a confidential file set in the security measure application.

### Means for Solving the Problems

In order to achieve the above object, the method of protecting a confidential file of a security measure application according to the present invention is characterized by comprising: a first step, in communication between an authentication module for authenticating an application that requests access to the confidential file and a communication module implemented in said security measure application by a challenge-response authentication scheme, if said communication module sends back a valid response code in response to a challenge code sent by said authentication module to said communication module, of authenticating the relevant security measure application as an application permitted to access the confidential file and recording the application as an authenticated application in a management table; and a second step by said authentication module, of capturing the relevant access request for the request of access to said confidential file, determining whether or not the application requesting access is an authenticated application that has been recorded in said management table, and inhibiting access to the confidential file if the application has not been authenticated, or permitting access if the application has been authenticated.

The method is also characterized in that said first step includes recording information of access right and an accessible period of an authenticated application to access the confidential file in said management table, and said second step includes permitting access to the confidential file within the recorded access right and accessible period.

The method is further characterized in that said first step includes recording a path name of an access permitted file in said management table in addition to the access right and accessible time period, and said second step includes permitting access to the confidential file within the recorded access right, accessible period and access permitted file path name.

The device for protecting a confidential file according to the present invention is a confidential file protecting device for protecting a confidential file of a security measure application being characterized by comprising: recording means, in communication between an authentication module for authenticating an application that requests access to the confidential file and a communication module implemented in said security measure application by a challenge-response authentication scheme, if said communication module sends back a valid response code in response to a challenge code sent by said authentication module to said communication module, for authenticating the relevant security measure application as an application permitted to access the confidential file and recording the application as an authenticated application in a management table; and access permitting means by said authentication module, for capturing the relevant access request for the request of access to said confidential file, determining whether or not the application requesting access is an authenticated application that has been recorded in said management table, and inhibiting access to the confidential file if the application has not been authenticated, or permitting access if the application has been authenticated.

Further detailed configuration of the invention will become apparent by the best mode to carry out the invention discussed below and the attached drawings.

According to the present invention, a communication module for authenticating a security measure application with an authentication module for authenticating the right to access a confidential file is implemented in the security measure application. The invention is configured to permit access to the confidential file only if the right to access the confidential file has been recorded through communication between the communication module and the authentication module, so that an invalid application that does not implement the communication module cannot access a confidential file.

The above configuration enables to surely defense a confidential file from a behavior to tamper the confidential file by an invalid application.

The authentication scheme is independent from an API issue event, hence the frequency of issuing authentication requests can be reduced and the implementation is capable of not degrade the performance as little as possible. Moreover, by setting access right for each authenticated application, a confidential file can be protected in a stronger and more assured manner.

The present specification incorporates the disclosure of specifications and/or drawings of Japanese Patent Application No. 2005-189676, which is a priority base of the present application.

### BRIEF DESCRIPTION OF THE DRAWINGS

FIG. 1 is a functional block diagram showing one embodiment (confidential file protecting device) according to the present invention;

FIG. 2 is a table diagram illustrating overall composition of application management information;

FIG. 3 is a table diagram illustrating overall composition of application information;

FIG. 4 is a diagram illustrating overall configuration of an application authentication scheme;

FIG. 5 is a diagram illustrating access to a confidential file from an authentication application;

FIG. 6 is a diagram illustrating access to a confidential file from a malicious program;

FIG. 7 is a flowchart illustrating access to a confidential file from a security measure application;

FIG. 8 is a flowchart illustrating application authentication by an authentication and file I/O capturing module;

FIG. 9 is a flowchart illustrating file I/O capturing by the authentication and file I/O capturing module;

FIG. 10 is a diagram showing another embodiment in which the present invention is applied;

FIG. 11 is a table diagram illustrating overall composition of application information of an application 1; and

FIG. 12 is a table diagram illustrating overall composition of application information of an application 2.

### DESCRIPTION OF SYMBOLS

1 computer (confidential file protecting device)
8 security measure application
10 confidential file
11 authentication and file I/O capturing module
81 communication module
111 authentication application management table
202 application information
304, 1104, 1204 accessible period
305, 1105, 1205 access right
1106, 1206 access permission file path name

### BEST MODE FOR CARRYING OUT THE INVENTION

The following will describe one mode for carrying out the present invention in detail with reference to the drawings.

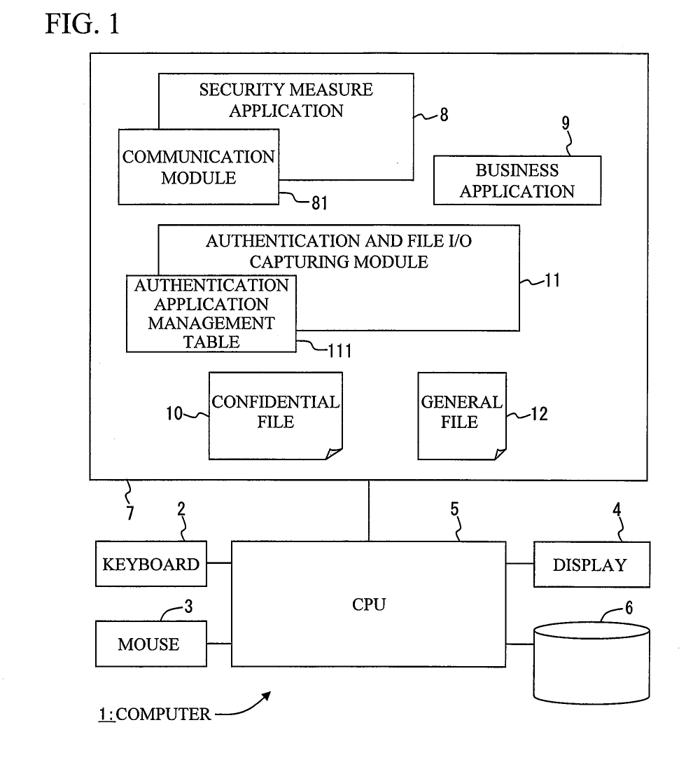

FIG. 1 is a functional block diagram showing one embodiment of a computer (a device for protecting a confidential file) in which the present invention is applied.

A computer 1 comprises a keyboard 2, a mouse 3, a display 4, a CPU 5, an external storage device 6 and a memory 7 for storing a security measure application 8 to be protected in the present invention. The memory 7 also stores a business application 9 used for various types of businesses.

The memory 7 further stores an authentication and file I/O capturing module 11 to protect a confidential file 10 of the security measure application 8.

The authentication and file I/O capturing module 11 comprises an authentication application management table 111. The module 11 captures authentication and a file I/O instruction of the security measure application 8 or other applications, and authenticates the applications according to management information recorded in the authentication application management table 111. The module 11 does not permit access to the confidential file 10 for a file I/O instruction from an application that has not been authenticated. On the contrary, the module 11 permits access to the confidential file 10 for a file I/O instruction from an application that has been authenticated within an access right or accessible time recorded in the authentication application management table 111.

The confidential file 10 stores confidential information such as policy definition information of the security measure application 8. A general file 12 is a file other than a confidential file.

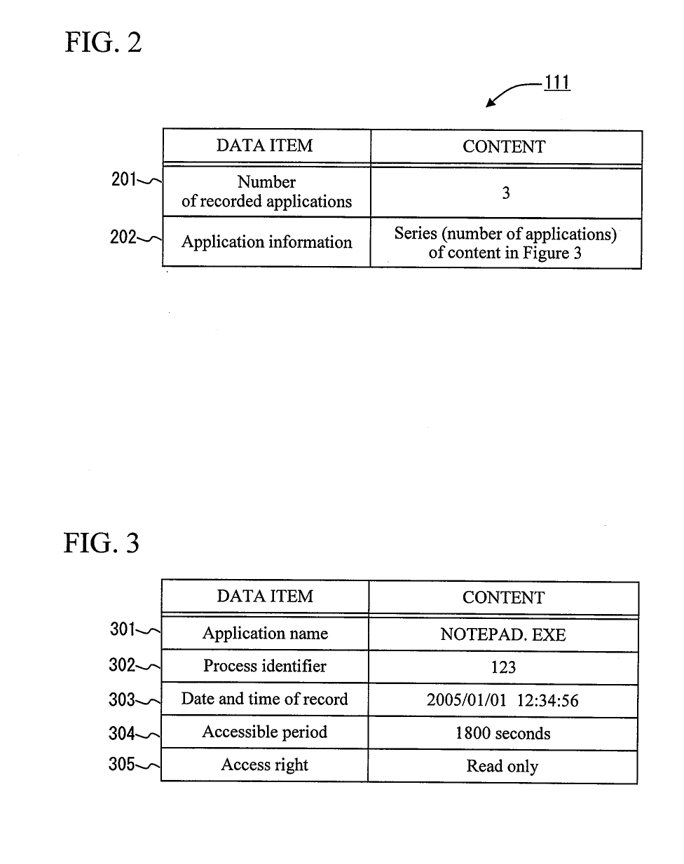

FIG. 2 is a diagram showing an example of storage and content of the authentication application management table 111 for an authentication and file I/O capturing module 102 to manage an authenticated application. The table 111 records the number of applications (number of recorded applications) 201 permitted to access the confidential file 10, and application information 202 including access rights for the applications and the like.

The application information 202 includes a name of an application 201 permitted to access the confidential file 10, a process identifier 302, date and time of record 303, an accessible period 304 and access right 305, as shown in FIG. 3. The application information 202 is recorded corresponding to each application permitted to access the confidential file 10.

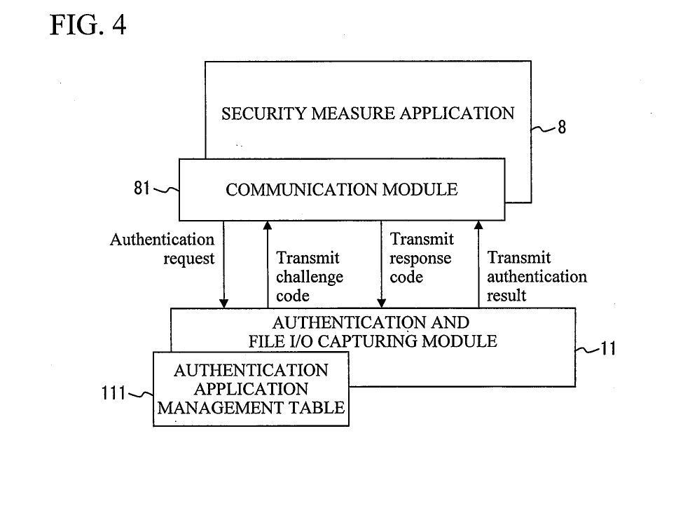

FIG. 4 is a diagram showing the flow of authentication of the security measure application 8 by the authentication and file I/O capturing module 11.

In an example in FIG. 4, authentication is performed using a challenge-response authentication scheme. Before the security measure application 8 refers to the confidential file 10, a communication module 81 implemented in the security measure application 8 issues an authentication request to the authentication and file I/O capturing module 11.

The authentication and file I/O capturing module 11 that has received the authentication request returns a challenge code to the security measure application 8 as a result of the authentication request.

The security measure application 8 that has received the challenge code performs a predetermined operation on the challenge code. For example, the application 8 performs operations such as encrypting a result of a logical operation of the challenge code and the current time or calculating a hash value.

The operation result is sent to the authentication and file I/O capturing module 11 as a response code.

The authentication and file I/O capturing module 11 compares a result of performing similar operations on the sent challenge code and the received response code. If they match each other, the module 11 records the security measure application 8 in the authentication application management table 111 as an authenticated application. If they do not match each other, the module 11 does not record the application but returns an authentication error result to the security measure application 8.

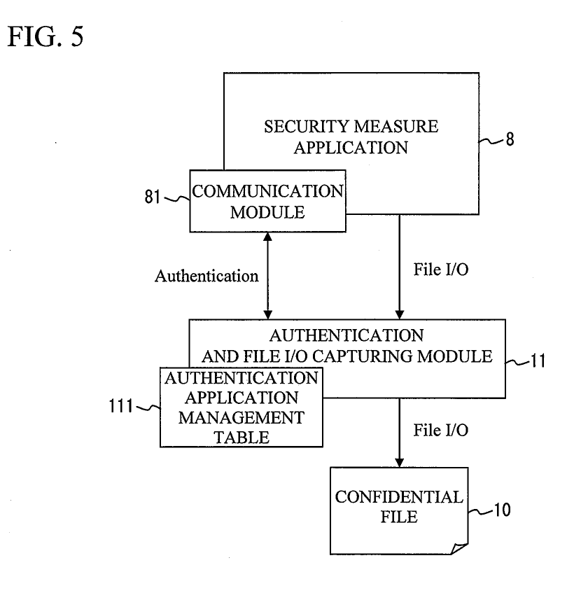

FIG. 5 is a diagram showing a mechanism for the authenticated security measure application 8 to refer to the confidential file 10.

The security measure application 8 has been authenticated by the authentication and file I/O capturing module 11 through the communication module 81, hence it has been already recorded in the authentication application management table 111.

When the security measure application 8 accesses the confidential file 10, a file I/O instruction to the confidential file 10 is issued.

The authentication and file I/O capturing module 11 captures the relevant file I/O instruction and searches the authentication application management table 111 for the requesting security measure application 8. Since the application 8 has been already recorded in the table 111, the module 11 permits the application 8 to access the confidential file 10 within access right and within an accessible period according to the application information 202 stored in the authentication application management table 111.

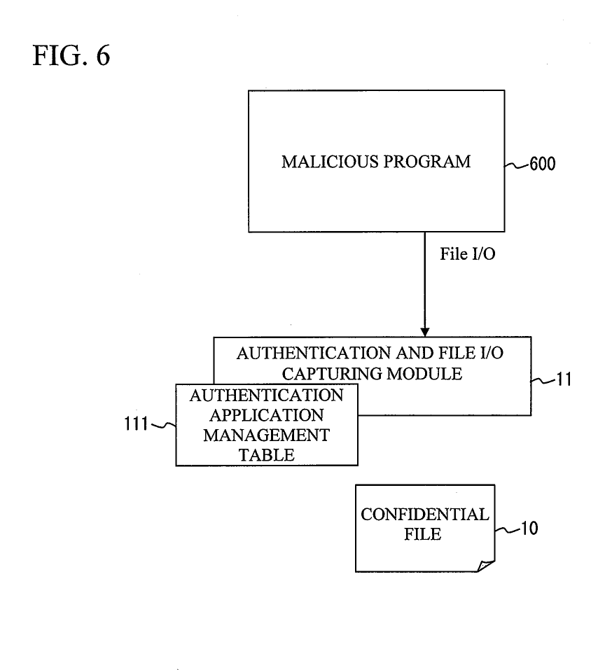

FIG. 6 is a diagram showing a mechanism to inhibit an invalid application 600 from accessing the confidential file 10.

The invalid application 600 cannot go through authentication of an application because it does not have a communication module function. Therefore, the application 600 is not recorded in the authentication application management table 111. When the invalid application 600 accesses the confidential file 10, a file I/O instruction to the confidential file 10 is issued.

An authentication and file I/O capturing module 111 captures the relevant file I/O instruction and searches the authentication application management table 111 for the requesting invalid application 600. Since the invalid application 600 has not been recorded in the table 111, the relevant file I/O instruction is returned to the requester as an error.

The above mechanism inhibits access to the confidential file 10 from the invalid application 600.

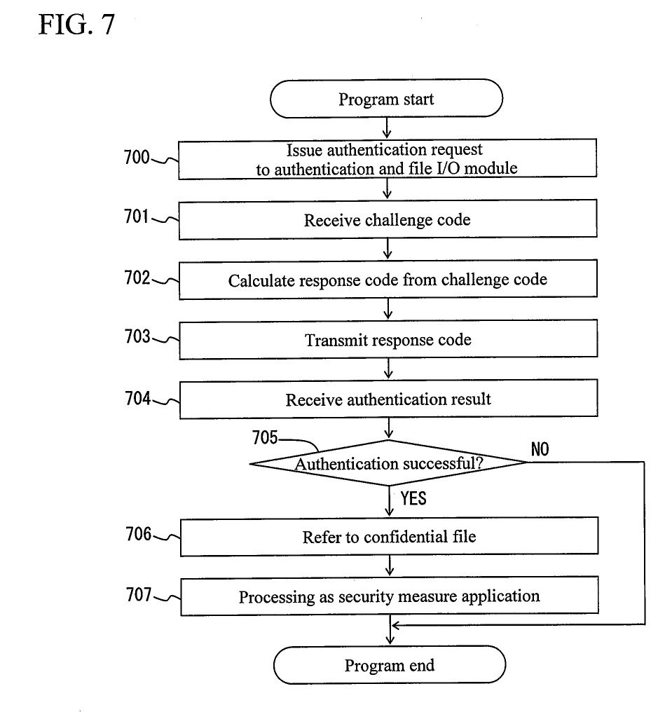

FIG. 7 is a flowchart showing a procedure for the security measure application 8 to request authentication and access the confidential file 10.

The security measure application 8 requires authentication of an application by the authentication and file I/O capturing module 11 before accessing the confidential file 10.

First, the security measure application 8 issues an authentication request to the authentication and file I/O capturing module 11 (step 700). Then, the security measure application 8 receives a challenge code as a result of the authentication request (step 701). In addition, the security measure application 8 performs predetermined arithmetic processing based on the received challenge code to calculate a response code (step 702), and sends the response code to the authentication and file I/O capturing module 11 (step 703). If the authentication fails, the security measure application 8 finishes a program since it cannot obtain information required for application to operate. If the authentication succeeds, the security measure application 8 refers the confidential file 10 (step 706), and performs processing as the security measure application 8 depending on the obtained operating environment or security policy (step 707).

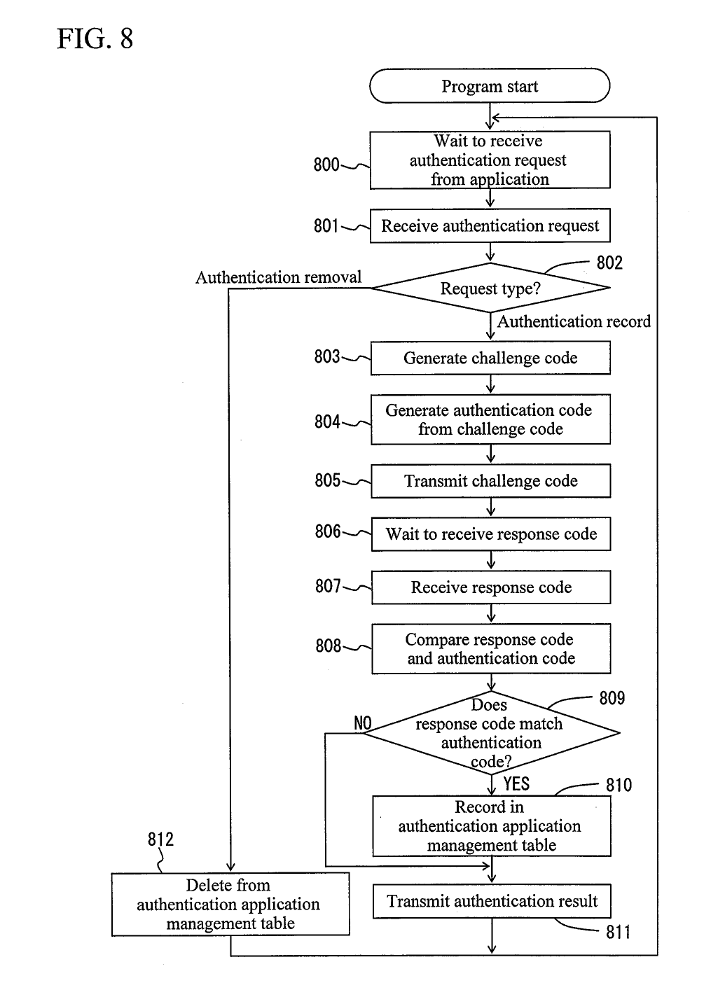

FIG. 8 is a flowchart showing a processing procedure for the authentication and file I/O capturing module 11 to authenticate an application.

First, the authentication and file I/O capturing module 11 starts the processing to wait for an authentication request by an application (step 800). When the module 11 receives the authentication request by the application (step 801), the authentication and file I/O capturing module 11 checks a type of the request (step 802).

If the request type is an authentication record request, the authentication and file I/O capturing module 11 generates a challenge code (step 803) and sends the code to the requesting application (step 805). In addition to the challenge code generating, the authentication and file I/O capturing module 11 performs predetermined arithmetic processing on the challenge code to generate an authentication code (step 804). Afterward, the authentication and file I/O capturing module 11 receives a response code from the requesting application (step 807), and compares the received response code and the generated authentication code (step 808) to determine whether or not the request is an authentication request by a regular application (step 809). If the response code matches the authentication code, the authentication and file I/O capturing module 11 records the application information 202 in the authentication application management table 111 (step 810).

Subsequently, the authentication and file I/O capturing module 11 returns an authentication result to the requesting application (step 811).

Otherwise, if the request type is an authentication removal request, the authentication and file I/O capturing module 11 deletes the application information 202 of the relevant application from the authentication application management table 111 (step 812).

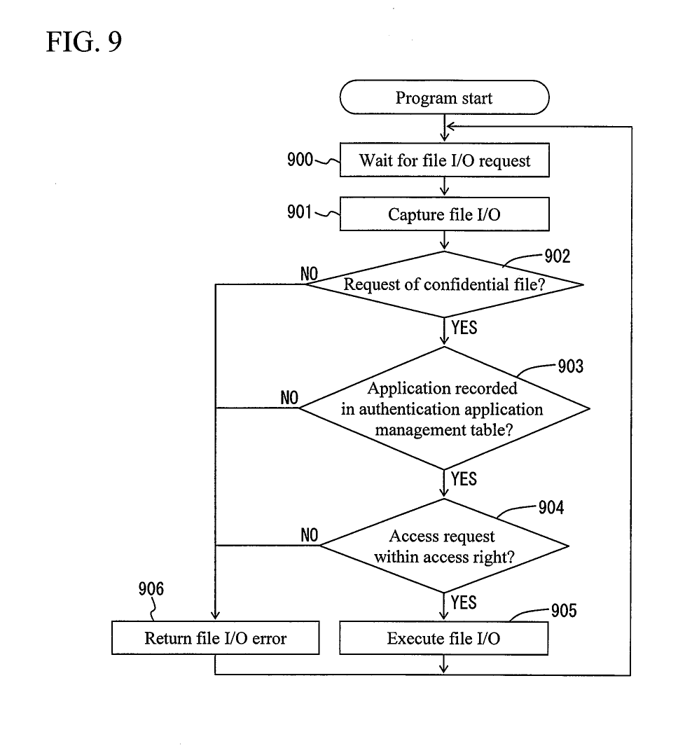

FIG. 9 is a flowchart showing a procedure for the authentication and file I/O capturing module 11 to capture access to the confidential file 10 and control the access.

The authentication and file I/O capturing module 11 starts the processing to wait for a file I/O instruction using a file I/O capturing function other than the application authentication function shown in FIG. 8 (step 900). When the module 11 captures the file I/O instruction such as a file OPEN request (step 901), the authentication and file I/O capturing module 11 checks whether or not the relevant I/O instruction is a request for the confidential file 10 (step 902). If the instruction is an I/O instruction to the confidential file 10, the authentication and file I/O capturing module 11 further performs search to determine whether or not an issuing application of the file I/O instruction has been recorded in the authentication application management table 111 (step 903). If the instruction is a file I/O instruction from an authenticated application, the authentication and file I/O capturing module 11 performs access control according to access right of the application information 202 recorded in the authentication application management table 111 (step 904).

For example, an application that is given read authority only as the access right can only refer to, but not write in, the confidential file 10. However, an application that is given write authority can edit the confidential file 10.

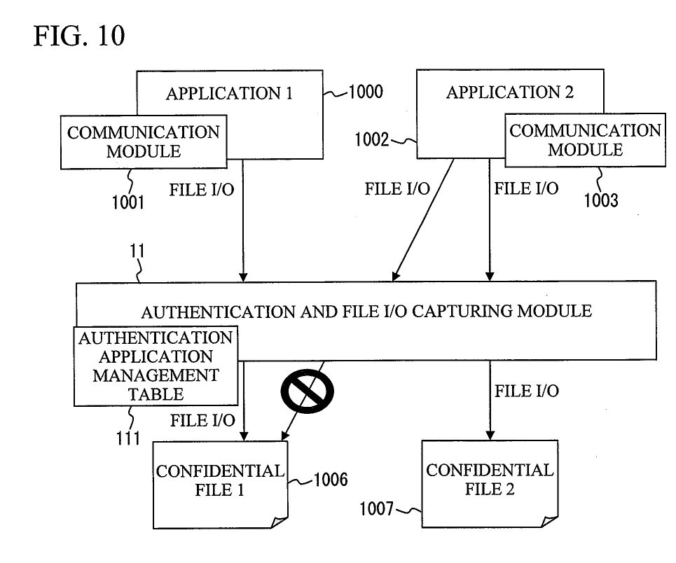

FIG. 10 is a diagram showing another embodiment in which the present invention is applied.

The embodiment comprises applications 1000 and 1002 including communication modules 1001 and 1003, respectively, functioning in the same way as the communication module 81 in FIG. 1.

Access to both of confidential files 1006 and 1007 as files to store confidential information is controlled by the authentication and file I/O capturing module 11.

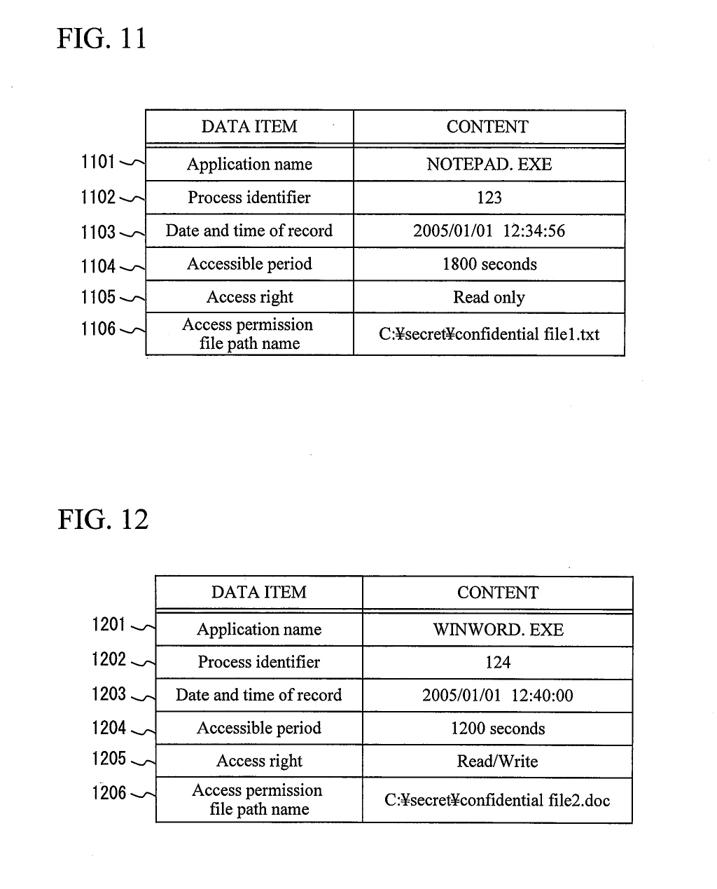

Extending authentication information to designate a path name of a file to be permitted access, application information for the application 1000 in the authentication application management table 111 is as shown in FIG. 11, for example. The application 1000 can issue an authentication request to access only its own confidential file 1006 (file path name “C:¥secret¥confidential file1.txt”).

Similarly, application information for the application 1002 in the authentication application management table 111 is as shown in FIG. 12, for example. The application 1002 issues an authentication request to access only its own confidential file 1007 (file path name “C:¥secret¥confidential file 2.doc”).

In FIG. 10, when the application 1002 tries to access the confidential file 1006 retained by the application 1000, it is determined not to have access right at step 904 in the access control procedure since an access permitted file path name 1206 in its own application information (FIG. 12) does not include the confidential file 1006 (file path name “C:¥secret¥confidential file1.txt”), hence it cannot access the confidential file 1006. Similarly, when the application 1000 tries to access the confidential file 1007 retained by the application 1002, it is determined not to have access right at step 904 in the access control procedure since an access permitted file path name 1106 in its own application information (FIG. 11) does not include the confidential file 1007 (file path name “C:¥secret¥confidential file 2.doc”), hence it cannot access the confidential file 1007. By distinguishing confidential files accessible by an application, fine access control can be realized.

All the publications, patents and patent applications referred to in the present specification are incorporated herein by reference.

The present invention is not limited to the above disclosed embodiments, but reconfiguration, variation and substitution are also possible without departing from the scope defined by the appended claims.

1. A method of protecting a confidential file of a security measure application, comprising:
a first step, in communication between an authentication module for authenticating an application that requests access to the confidential file and a communication module implemented in said security measure application by a challenge-response authentication scheme, if said communication module sends back a valid response code in response to a challenge code sent by said authentication module to said communication module, of authenticating the relevant security measure application as an application permitted to access the confidential file and recording the application as an authenticated application in a management table; and
a second step by said authentication module, of capturing the relevant access request for the request of access to said confidential file, determining whether or not the application requesting access is an authenticated application that has been recorded in said management table, and inhibiting access to the confidential file if the application has not been authenticated, or permitting access if the application has been authenticated.

2. The method according to claim 1 wherein:
said first step comprises recording information of access right and an accessible period of an authenticated application to access the confidential file in said management table; and
said second step comprises permitting access to the confidential file within the recorded access right and accessible period.

3. The method according to claim 2 wherein:
said first step comprises recording a path name of an access permitted file in said management table in addition to the access right and accessible time period; and
said second step comprises permitting access to the confidential file within the recorded access right, accessible period and access permitted file path name.

4. A confidential file protecting device for protecting a confidential file of a security measure application, comprising:
recording means, in communication between an authentication module for authenticating an application that requests access to the confidential file and a communication module implemented in said security measure application by a challenge-response authentication scheme, if said communication module sends back a valid response code in response to a challenge code sent by said authentication module to said communication module, for authenticating the relevant security measure application as an application permitted to access the confidential file and recording the application as an authenticated application in a management table; and
access permitting means by said authentication module, for capturing the relevant access request for the request of access to said confidential file, determining whether or not the application requesting access is an authenticated application that has been recorded in said management table, and inhibiting access to the confidential file if the application has not been authenticated, or permitting access if the application has been authenticated.

5. The confidential file protecting device according to claim 4 wherein:
said recording means records information of access right and an accessible period of an authenticated application to access the confidential file in said management table; and
said access permission means permits access to the confidential file within the recorded access right and accessible period.

6. The confidential file protecting device according to claim 5 wherein:
said recording means further records a path name of an access permitted file in said management table; and
said access permission means permits access to the confidential file within the recorded access right, accessible period and access permitted file path name.
